(19) United States
(12) Patent Application Publication
(10) Pub. No.: US 2017/0096590 A1
(43) Pub. Date: Apr. 6, 2017

(54) FORM STABILIZED PHASE CHANGE COMPOSITIONS

(71) Applicant: Smart PCM Patent Holdco, LLC, Loveland, CO (US)

(72) Inventors: John A. Geohegan, Longmont, CO (US); Joseph B. Parker, Longmont, CO (US)

(21) Appl. No.: 14/873,200

(22) Filed: Oct. 2, 2015

(51) Int. Cl. C09K 5/06

(52) U.S. Cl. CPC C09K 5/063

(57) ABSTRACT

Provided herein are form stabilized phase change materials and methods of their manufacture. Form stabilized phase change material compositions comprise porous particulate carriers impregnated with at least one phase change material. The particulate carriers are of a specific size range depending on the density and loading capacity of the particles. Exemplary carriers include expanded perlite with a particle size of greater than approximately 0.5 millimeters. In some examples, the products may have phase change material at 40% or more of the final composition by volume. Additionally, methods of manufacturing the form stabilized phase change materials are provided, and exemplary building materials and shipping containers are provided.

### FIELD

The disclosure relates generally to the field of phase change material compositions and methods of their manufacture.

### BACKGROUND

Phase change materials (PCMs) are products that store and release thermal energy in the form of latent heat upon changing from one phase to another (i.e. melting or freezing), and are used in a wide variety of applications. In a typical use, PCMs are placed in building materials that are then placed in structures, and are useful in moderating daytime-to-nighttime temperature fluctuations. PCM-based building materials also allow for timing of energy consumption in the heating or cooling of a structure. PCM-based materials are also useful in, e.g., shipping and transport, as well as for other uses. The general properties of phase change materials and their usefulness is described in the art.

PCMs encompass a large number of compounds useful for the above purposes, as discussed in U.S. Patent Publication 2013/0298991 to Parker et al., hereby incorporated by reference in its entirety. Typical PCMs are hydrated salts, or hydrated salts with glycols or hydrocarbon waxes. Due to the requirement for building materials to be substantially solid, upright, and load-bearing to some extent, form stabilized or shape-stabilized PCM is often used for those applications. Form- or shape-stabilized PCM refers to PCM disposed in a support structure, such as a porous material, and may incorporate additional structural impediments, e.g. baffles, to prevent the material from compacting into one area of the overall form factor. Other approaches to preventing leakage primarily feature microencapsulation.

A typical support structure for PCM loading is a porous expanded particle material, as discussed in U.S. Pat. No. 7,704,405 to Ottinger et al., hereby incorporated by reference in its entirety. Perlite is generally the preferred expanded mineral particle for PCM loading applications, as it is widely available and used in a variety of building materials. Perlite in its raw state is a naturally occurring material of volcanic origin, and has a high silica content. In typical building material and other applications, perlite ore is subjected to high heat to expand grains into a light-weight, high-volume form. This process is similar to that of popping corn kernels using high heat, and typically leads to 4×-20× size expansion. Once expanded, perlite particles are relatively chemically inert and temperature resistant, and can be a platform for loading additional building materials, such as PCMs.

Pre-expanded perlite varies greatly between sources or even within a single mine, with highly variable water content between source ores. There is vast variation in the size, density, and porosity of individual expanded perlite grains within each commercially-obtainable batch, attributable to a lack of facilities for testing perlite sources and the expense of the equipment required to generate material of a consistent size. Due to the low price of expanded perlite, which is sold on a cubic foot or larger bulk volume basis, there is little incentive for manufacturers to provide a highly consistent product graded by size and density, or to test porosity or loading capacity. In fact, expanded perlite is generally sold in one of several categories such as superfine to supercoarse, and there is substantial overlap among grades.

The high variation in size, density, and porosity seen in commercially-available pre-expanded perlite leads to difficulty in predicting any sample's specific PCM loading capacity, which varies greatly by source and specific batch. Because maximum PCM loading is typically desirable, both overloading and underloading occur often. Underloading of expanded materials with PCM leads to low performance of the final product, and may not store enough energy to be useful in certain applications. Overloading results in additional expense without improved function, and also leads to seepage, which can harm building materials and require material replacement. While attempts have been made to control seepage and leakage with PCMs, these have often proven unsuccessful.

The disclosure herein provides methods and materials that overcome one or more of the problems outlined above.

### SUMMARY

Aspects of the disclosure provide a process of manufacturing a form stabilized phase change material by sieving a bulk porous carrier to a specific range of particle sizes, then combining the sieved porous carrier with a liquid phase change material to form a form stabilized material. In some embodiments, the bulk porous carrier may be sieved to a particle size of at least approximately 0.5 mm. In other embodiments, the particle size is approximately 0.5 mm-10.0 mm. In specific embodiments the particle size is approximately 0.5 mm-4.0 mm. In other embodiments, the particle size is greater than 4.0 mm, and may be considerably larger, e.g. greater than 10.0 mm.

Though any suitable carrier may be used, in some embodiments, the carrier is one or more of an expanded perlite, high density polyethylene, styrene, butadiene, zeolite, diatomaceous earth, vermiculite, plaster or gypsum, concrete, expanded graphite, or clay mineral. In specific examples, the carrier is an expanded perlite or zeolite. In some embodiments, the carrier has a density of less than approximately 10 lb per cubic foot.

Any suitable phase change material may be used. In some embodiments, the phase change material has a melt point between −30° C. and 100° C., and in some embodiments the phase change material has a melt point above 100° C. In particular embodiments, the phase change material is one or more alkane. Alkanes may include hexadecane, octadecane, and/or tetradecane. In some embodiments, the phase change material is hexadecane with a melting point of 18° C.

In some embodiments, the process further comprises performing a vacuum step. In other embodiments, the process further comprises adding fine particles of one or more dry materials. In some embodiments, the fine particles may be expanded perlite particles. In other embodiments, the fine particles may range in size from approximately 0.2 mm-1.0 mm.

In some embodiments, the phase change material is 40% or more of the final composition by volume.

A form stabilized phase change material is also provided. In some embodiments, the form stabilized phase change material comprises a porous carrier with a particle size of approximately 0.5 mm-3.0 mm and a phase change material. In some embodiments, the carrier is impregnated with the phase change material. Any suitable carrier may be used, and in some embodiments is one or more of an expanded perlite, high density polyethylene, styrene, butadiene, zeolite, diatomaceous earth, vermiculite, plaster or gypsum, concrete, expanded graphite, or clay mineral. In some embodiments the carrier has a density of less than 10 lb per cubic foot. In some embodiments, the particle size is at least approximately 0.5 mm. In other embodiments, the particle size is approximately 0.5 mm-10.0 mm. In specific embodiments the particle size is approximately 0.5 mm-4.0 mm. In other embodiments, the particle size is greater than 4.0 mm, and may be considerably larger, e.g. greater than 10.0 mm.

In some embodiments, the form stabilized phase change material further comprises particles of one or more dry materials. In some embodiments, the dry material is a dry particle, and may be a dry perlite particle that is either expanded or non-expanded. In some embodiments, the dry particle size is 0.2 mm to 1.0 mm.

In some embodiments, the phase change material is 40% or more of the final composition by volume. In other embodiments, the phase change material has a melt point between −30° C. and 100° C. In some embodiments, the phase change material has a melt point above 100° C.

Form stabilized phase change materials may be combined with a building material. In some embodiments, the building material is a composite material, and may be a concrete or chemically bonded ceramic. In other embodiments, the building material is a loose insulation. In some embodiments, a packing or shipping material comprising a form stabilized phase change material is provided.

### BRIEF DESCRIPTION OF THE FIGURES

FIG. 1 shows the decrease in relative (to Source A and Source B perlite) PCM loading capacity as perlite density (lb per cubic foot) increases. The line passes through the data from all of the samples.

### DETAILED DESCRIPTION

The examples and descriptions provided herein are non-limiting examples, and are not to be construed as limiting the scope of the claims. As used herein, the following definitions are provided:

“Form stabilized” as used herein refers to a phase-change composition that has the capacity to retain its shape when changing phases. Typically, these materials have large apparent specific heat for phase change temperature region as well as the suitable thermal conductivity to readily change phase. This term may be generally seen as “shape stabilized” in the art, and in many instances may overlap with this term. In specific embodiments, the melting point is room temperature. The composition may be in any physical shape or form, such as single piece of any size, and may also be provided as aggregates or particles. In some embodiments, the composition may be a monolithic mass, or may be shaped to any suitable form, e.g. to fit into the wall of a building or container.

“Phase change material” as used herein refers to any material exhibiting a phase change within a desired temperature range. The phase change may be any suitable phase change with a latent heat associated with the phase change. The phase change may be a change from one crystal state to another crystal state (crystalline phase change). The phase change may be a liquid-solid phase change. The phase change material may be an organic material (e.g., hydrocarbons, waxes). The phase change material may be an inorganic salt material (e.g., hydrated). In preferred embodiments, the phase change material comprises hydrocarbon or hydrocarbons (e.g., wax) having a liquid-solid phase change within a desired temperature range, and may be a paraffin or other wax. Additional examples of phase change materials and explanation of their selection for specific purposes may be found in U.S. 2013/0298991 to Parker et al., incorporated by reference above. In particular embodiments, the phase change material is one or more alkane. Alkanes may include hexadecane, octadecane, and/or tetradecane. In some embodiments, the phase change material is hexadecane with a melting point of 18° C.

“Carrier” as used herein refers to any suitable substrate for holding, carrying, or retaining a phase change material, and in instances may be used interchangeably with “substrate”. In typical embodiments, the carrier is a particulate matter, such as a granule. In other embodiments, it may be a solid, partially-solid, hollow, or other mass. In preferred embodiments, the carrier is a commonly-available granular material.

“Porous” and “porosity” as used herein refer to the degree to which a particle or portion comprises voids or empty space within its volume that may be accessed from the exterior. In some embodiments, the particles or granules used herein have relatively large open internal volume, as well as a high degree of accessibility to said internal volume, e.g. by cracks or pores on the particle surface.

“Sieve” and “sieving” as used herein refer to methods of sorting compositions by size exclusion, and may refer to any suitable method of performing size exclusion. In particular embodiments, a size-exclusion screen or mesh is used to isolate particulate or granular matter having a desired smallest diameter corresponding to the size of the sieve.

Note that “particle size” as used herein refers to approximate particle sizes and ranges of particle sizes, and may refer to an average particle size. Due to the nature of the materials used in various embodiments, variations in particle size will occur in any given sample or sieved product. Such variations, if within the overall specifications provided herein, do not detract from the usefulness of different embodiments.

“Impregnated” as used herein refers to soaking or saturating a substrate or carrier with a substance, and may be used interchangeably with “loading”. In typical embodiments, the substance is a PCM. Impregnated materials may or may be partially saturated, fully saturated, or overly saturated depending on the specific application. In a particular embodiment, a particulate carrier having at least some porosity is soaked in a PCM material, causing the PCM material to enter the pores of the carrier. In a specific embodiment, this process is carried out under vacuum, causing escaping air to draw PCM material into the pores or voids of the carrier granules.

“Building material” as used herein broadly refers to any material useful in constructing a building for any purpose. In particular examples, building materials may include concrete, wood, or metals. Building materials may also refer to combinations of various materials useful for the above purpose. In specific embodiments, the building materials are wallboards used in enclosing an interior space.

“Packing container” or “shipping container” and similar terms, as used herein, refer to enclosures useful for the storage and/or shipping of materials. In some embodiments, the container may be used in refrigerated shipping or storage, for example in the shipping or storage of temperature-sensitive materials, such as but not limited to biological materials or pharmaceuticals. Such containers may be of any size, and for any form of packing, shipping, or storage, including without limitation envelopes, postal boxes, freight boxes, trailers, train cars, cargo areas, and the like.

### Improved Processing of Carrier Materials

Carrier materials used in phase change compositions are typically sold in a commercial graded state. Commercial grading categories are very broad, however, as useful materials, e.g. an expanded porous material like perlite, are typically very inexpensive, and thus only financially feasible to produce at extremely high volume. Additionally, many of the commercial applications, such as agricultural and general building material applications, do not require narrowly graded materials, providing little incentive for manufacturers to improve their equipment and processes to make graded materials for more specific uses.

Due to the low price of these materials, which are sold on a cubic foot or larger bulk volume basis, there is little incentive for manufacturers to provide a highly consistent product graded by size and density, or to test porosity or loading capacity for PCM applications. In fact, expanded perlite is generally sold in grades such as superfine to supercoarse, with sieve analysis (found in the examples section below) indicating a large variation in the sizes of any sample of any grade, and most notably with respect to the inclusion of smaller particles in coarser grades.

Loading of expanded carrier materials with PCM is a known method of improving the delivery and form factor of PCM for commercial use, such as in a wallboard. As discussed in the cited art, PCMs benefit from being held in a particle or other structural matrix, as they are otherwise likely to leak out of building materials, causing damage to property. In fact, any material omitting such a carrier material is unlikely to provide a stabilized form factor, and will likely require additional packaging or sealing to prevent leakage.

A commonly seen problem with form stabilized PCM is that incorporation of a carrier limits the amount of PCM that can be placed in any given volume. Because the PCM is responsible for the majority of the beneficial heat transfer properties provided by the materials that it is incorporated into, maximal loading is desirable, and any reduction in loading capacity may reduce the effectiveness of the material. This is even more important in building material and shipping or storage applications, as the allowable volume of PCM is necessarily limited by the final form factor, e.g. a wall thickness.

Presently, the inventors have identified and expanded on the importance of the relationship between particle size, density, and loading capacity. Specifically, the inventors found that the overall density of the material and internal volume are largely responsible for a given particle's ability to absorb a PCM. They discovered that particles in relatively narrow size ranges have the optimum combination of porosity and high ratio of volume to surface area, and that by selecting a porous particulate within an appropriate size range, the volume of PCM absorbed is greatly improved. Because commercially graded sources of expanded materials, such as perlite, vary greatly in particle size within each grade, they require additional processing to result in an optimized carrier for PCMs.

While some prior art has examined PCM loading by various techniques, none have focused on a narrow range of optimized particle sizes evaluated by the inventors, and none have optimized loading to the extent seen in the present disclosure. In fact, in using the provided methods, one can see 40% or greater loading by volume depending on material, as well as having the vast majority of the PCM in the internal pores of the carrier, instead of on the surface. Having the PCM on the inside of the carrier also prevents unwanted dispersion and minimizes the risk of leakage.

While specific particle sizes and materials are referenced herein, the evaluation of PCM loading based on material can be done for a number of different particle sizes and materials, depending on form factor and end use.

### Size Exclusion of Carrier Particles

In embodiments of the process, a form stabilized phase change material is manufactured by first sieving a porous carrier to a particle size that reflects the preferred volume and surface area characteristics for that specific material. Carriers of particular interest include, but are not limited to, expanded perlite, high density polyethylene, styrene, butadiene, zeolite, diatomaceous earth, vermiculite, plaster or gypsum, concrete, expanded graphite, or clay mineral. In preferred embodiments, expanded perlite or zeolite are used, as they are commonly available, already used heavily in various industries, and have good porosity for PCM loading. It is well known that a variety of pore sizes are observed in expanded perlite, and that this contributes to the overall thermal properties and phase changing behavior of PCM-impregnated perlite (Zhang et al., Granular phase changing composites for thermal energy storage. Solar energy 2005; 78:471-480.).

In some embodiments, the porous carrier may have a density of less than 10 pounds per cubic foot. Because density is related to the overall size and porosity of the material, the density of a sample can be used as an initial quality control or screening tool.

In perlite embodiments herein, grains of less than about 1 mm have negligible internal volumes and too much comparative surface to optimally load PCM. The primary grains of the embodiment are typically larger than 0.5 mm, more preferably larger than 1.0 mm, and optimally about 3.5 mm. Smaller grains may also be included in a sample to some extent however, and in some cases may act to further eliminate potential seepage, as discussed elsewhere. Larger grains may also be included, depending on the size and form factor of the final application, and may be larger than 4.0 mm or larger than 10.0 mm.

Note that while optimal perlite sizes may be in the 0.5-4.0 mm range, the optimal size range for materials of different density and porosity may also be determined using the methods of different embodiments, and are likely to differ from perlite, though the effect of the volume to surface area will drive sizes to a similarly narrow range of particle sizes. In some embodiments, the size range may be below 0.5 mm, above 0.5 mm, above 4.0 mm, or above 10.0 mm, and may be narrower or broader than for perlite embodiments.

Carriers may be size sorted by any means, including but not limited to size exclusion, e.g. by screening or sieving. In a preferred embodiment, the carrier is sieved through a series of screens to obtain the desired particle size. This method has the benefit of being relatively fast, inexpensive, and scalable. Other methods contemplated herein include density or weight exclusion, and multiple sorting processes may be run on the carrier.

### Loading the Carrier With a Phase Change Material

After initial processing the carrier is combined with the phase change material in a liquid state. Such combination may be in the form of, e.g., a liquid emulsion. In some embodiments, the phase change material (PCM) is heated to achieve a liquid state, and in other embodiments it may be in a liquid state at ambient temperature.

Phase change material may be selected as described in the prior art, e.g. for use in a specific application based on its thermal transfer or other properties. One feature may be the ability to optimally load a wide range of PCMs into a given carrier. In a typical embodiment, the phase change material may be a wax, such as a paraffin wax. Phase change materials may have any desired melt point, and the melt point may be, e.g., between −30° C. and 100° C., or above 100° C.

In some embodiments, the carrier and liquid PCM are combined and allowed to rest for a period of time. This promotes liquid PCM filling pores on the carrier, and may be performed for e.g., approximately 1 minute, approximately 5 minutes, approximately 10 minutes, approximately 30 minutes, or over 30 minutes. The composition may be optionally heated during the saturation phase to keep the PCM in a liquid, flowable state. The process may also be monitored for changes in volume of free PCM or volume of released trapped air, which may indicate the progress of the impregnation process.

In certain embodiments, vacuum impregnation is used. Vacuum impregnation of porous PCMs perlite is known in the art, and both increases the overall PCM loading and decreases the amount of time required for loading (see Nomura et al., Impregnation of porous material with phase change material for thermal energy storage. Mat. Chem. and Phys. 2009;115:846-50, hereby incorporated by reference in its entirety). In some embodiments, vacuum impregnation has a synergistic effect with size exclusion, as optimized surface to volume ratios and material grade sorting increase the overall accessible volume of granules of the composition relative to other methods.

After impregnation, excess PCM may be removed if present, e.g. by draining In some embodiments, free PCM is substantially drained or filtered out from the loaded carrier. Non-entrapped PCM is typically undesirable because it can leak and undermine the overall form and function of the material, as discussed above. Additionally, other materials may be introduced at this stage. Optional materials are known in the art, and include additives such as, but not limited to, sorbent, fire resistant materials, binders, and the like, suitable for the end use of the material.

In certain embodiments, additional small particles or granules of carrier material may be introduced to the composition, i.e. to absorb any leaking PCM and prevent seepage. In these embodiments, any dry (i.e. not exposed to PCM) carrier may be used. In typical embodiments, granules that are smaller than the primary sorted particle size are used, and may be an expanded carrier. In a preferred embodiment, small expanded perlite granules are used. In some embodiments, these perlite granules have a particle size of approximately 0.2 mm-1.0 mm.

Additional small grains work to prevent potential seepage because they are self-wetting, and have a relatively high amount of surface area to volume and can trap any PCM that leaks from the larger granules. The inclusion of a limited amount of small dry grains does not decrease the loading capacity of larger grains because the small grains fit in the voids between larger grains. Thus, it is possible to attain the same level of overall performance as without the smaller dry particles, but while using a lower volume of PCM, and without changing the overall volume of the composition.

In these embodiments, the overall form stabilized material may have improved form and stability due to the removal of surface PCM. This may have additional synergistic effects that contribute to improved form stabilization and further reduce leaking or seepage.

### Form Stabilized Products

After the one or more steps above, the material is stabilized. In some embodiments, the material is poured into a suitable mold or receptacle. The creation of specific form stabilized PCM shapes and materials is described in the art, for example in U.S. Patent Publication 2013/0298991 to Parker et al.

In some embodiments, the phase change material makes 30% or more of the composition by volume. In other embodiments, the phase change material makes up 40% percent or greater of the composition by volume. As discussed in the examples below, higher loadings have been observed, and are contemplated herein.

Further contemplated are compositions comprising form stabilized PCM and one or more building materials. In some embodiments, this may be a composite material, and may be a concrete or chemically bonded ceramic. In other embodiments, the building material is a loose insulation. Note that other building materials are expressly contemplated as recognized in the art. Building material embodiments may directly incorporate the form stabilized PCM products provided herein, may surround a form factor of the products herein, or may form exterior or interior walls supporting the material.

In some embodiments, a packing or shipping container is provided. The form stabilized product may be incorporated as, e.g., a shell or baffle in the container. Due to the improved thermal properties for a given overall volume of material, the products described herein are particularly useful in smaller form factors, e.g. those accepted by common commercial carriers, and may reduce shipping costs. In some embodiments, the improved thermal properties allow temperature-sensitive materials to be shipped at reduced expense.

### EXAMPLES

The following examples are provided to illustrate aspects of different embodiments, and in no instance should be considered to limit the scope of the claims.

### Example 1

### Analysis of Expanded Perlite Grades

The information on six grades of expanded perlite from one supplier was obtained. The supplier sieved its expanded perlite in a series of screens, including 500 g, 1 mm, 2 mm, 4 mm, and 8 mm screens. The manufacturer then weighed the resulting size-separated expanded perlite granules to determine the relative amount of particles of each size range in each sample, as shown in Table 1. Density analysis was also performed, as shown in Table 2. Air porosity analysis was performed, as shown in Table 3. Also, water holding capacity was determined, as shown in Table 4.

TABLE 1
Relative size of particles across expanded perlite grades

| Particle | | | | | Premium | |
|---|---|---|---|---|---|---|
| Size | Superfine | Fine | Medium | Coarse | Coarse | Supercoarse |
| >8 mm | — | — | — | — | 20% | 70% |
| >4 mm | — | — | — | 40% | 64% | 28% |
| >2 mm | — | 30% | 80% | 59% | 15% | 2% |
| >1 mm | 60% | 50% | 20% | 1% | 1% | |
| >500μ | 40% | 20% | — | — | — | |
| Pan | — | — | — | — | — | |

TABLE 2
Density analysis of perlite grades, in grams per liter

| | | | | Premium | |
|---|---|---|---|---|---|
| Superfine | Fine | Medium | Coarse | Coarse | Supercoarse |
| 35-40 g/L | 35-45 g/L | 45-60 g/L | 45-60 g/L | 55-70 g/L | 55-70 g/L |

TABLE 3
Air porosity of perlite grades, in
percent volume of void space (v/v)

| | | | | Premium | |
|---|---|---|---|---|---|
| Superfine | Fine | Medium | Coarse | Coarse | Supercoarse |
| 25% v/v | 38% v/v | 48% v/v | 58% v/v | 70% v/v | 80% v/v |

TABLE 4
Water holding capacity of perlite grades, in percent of volume (v/v)

| | | | | Premium | |
|---|---|---|---|---|---|
| Superfine | Fine | Medium | Coarse | Coarse | Supercoarse |
| 50% v/v | 43% v/v | 34% v/v | 21% v/v | 19% v/v | 17% v/v |

As shown in Table 1, there is a high degree of variation in particle size within a sample of any individual grade, with a more noticeable effect as the grade size gets larger. Most embodiments herein use medium or coarse grades, though the use of other grades is contemplated. As the results show, commercially available samples have too much native variation to provide properly-sized particles that enable optimal loading, and further sorting is required.

Table 2 also reveals that the size grades used by manufacturers are not particularly effective at sorting for density, with large overlapping ranges between many of the grades. Tables 3 and 4 show the varying volume of air and water storage capability in samples of different grades, discussed elsewhere with respect to contribution to overall particle loading.

The range seen in the properties of the different perlite grades exemplifies the importance of determining the properties of perlite sources and further separating them into more specific size and density categories before loading with PCM.

### Example 2

### Analysis of Density and PCM Capacity Across Commercial Perlites

Commonly-available commercial bulk perlite products were purchased from a manufacturer. The dry density was measured, as shown in Table 5. The PCM used for the experiments herein was paraffin wax, which provides a good model for other PCMs, and has been shown to have nearly identical loading and other properties as other similar PCMs, though the phase change temperature differs.

PCM loading capacity, in volume per perlite bulk volume (Table 6) and relative volume capacity as compared to Source A and Source B (Table 7), was determined for all products.

TABLE 5
Perlite density (lb/cu.ft.) across commercial bulk perlite products

| | Source | Source | | Source | Source | |
|---|---|---|---|---|---|---|
| Source A | B | C | Source D | E | F | Source G |
| 2.25 | 4.3 | 4.4 | 5.1 | 6.0 | 7.5 | 10.6 |

TABLE 6
PCM volume to perlite bulk volume (percent)

| | Source | Source | | Source | Source | |
|---|---|---|---|---|---|---|
| Source A | B | C | Source D | E | F | Source G |
| 43% | 43% | 37% | 37% | 33% | 29% | 23% |

TABLE 7
Relative PCM volume capacity based on perlite density (lb/cu.ft)

| | Source | Source | | Source | Source | |
|---|---|---|---|---|---|---|
| Source A | B | C | Source D | E | F | Source G |
| 100% | 100% | 87% | 87% | 78% | 69% | 53% |

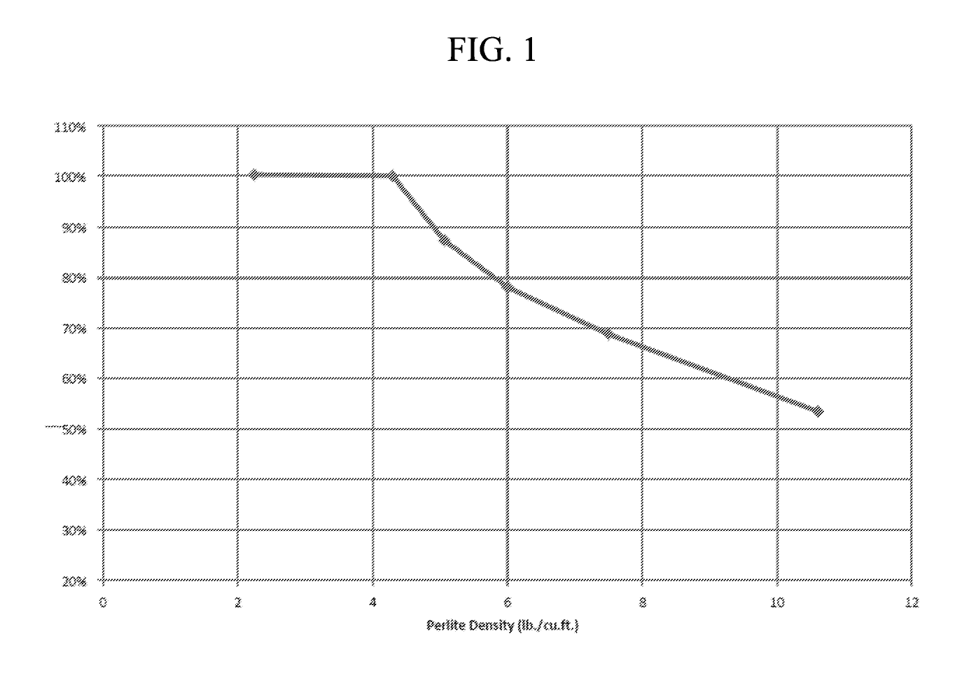

As shown in Tables 5-7 as well as in FIG. 1, PCM loading tends to decrease as sample density increases.

### Example 3

### Perlite Particle Size Separation

Perlite from source B was obtained and inspected. The sample was then ran through a series of ASTM standard sieves. First, number 4 and number 6 sieves were used on the sample to separate large chunks and grains. The number 6 sieve has a nominal opening of 3.4 mm, allowing desirable particle sizes to pass through. The sample was then ran through a number 8 sieve (2.4 mm), and the retained material was kept (2.4-3.4 mm sizes). Note that in many instances, more cylindrical or long particles may pass through the filter, and grains may be longer than the 3.4 mm sieve size.

In some cases, smaller material was also sieved into grains with sizes between 0.2 mm and 1.0 mm. This material is reserved for optional later inclusion as dry grains, as discussed above.

### Example 4

### Creation of a PCM-Impregnated Perlite Product

Expanded perlite was sieved as discussed in the previous examples. Phase change material (coconut oil) was heated to its liquid phase, then poured over the expanded perlite. After 30 minutes, but while still in a fluid state, any phase change material that was not absorbed by the carrier was drained out of the container. The resultant product is form stabilized.

Note that coconut oil is an exemplary PCM used for availability and reduced experimental costs, and that any phase change material may be suitable for use in the method.

### Example 5

### Further Processing Methods

Expanded perlite was sieved as discussed in the previous examples. Phase change material (coconut oil) was heated to its liquid phase, then poured over the expanded perlite. The mixture was then held under vacuum for 30 minutes to allow the phase change material to fill the voids in the expanded perlite. Any phase change material that was not absorbed by the carrier was then drained from the container. The resultant product was form stabilized.

Note that in this example, the amount of PCM absorbed (i.e. not poured out or removed) by the expanded perlite was more than 2.5 times the amount absorbed by grains dipped in hot PCM as a control sample. This degree of additional absorption indicates that vacuum preparation is a highly effective means of impregnating the material with PCM.

### Example 6

### Additional of Crushed Dry Perlite

Expanded perlite was sieved as discussed in the previous examples. Crushed expanded perlite was also sieved to obtain grains between 0.2 mm and 1.0 mm. A small amount of the sieved crushed expanded perlite was then mixed into the vacuum impregnated grains sample.

The addition of a relatively small amount of crushed grains did not increase the overall volume of the sample.

The preceding description is presented for purposes of illustration and description, and does not limit the scope of the claims to the disclosures, examples, and embodiments provided therein. On the contrary, a number of modifications and variations are possible based on the above teachings, and alternative embodiments are included to the full scope allowable by the prior art.

What is claimed is:

1. A process of manufacturing a form stabilized phase change material, comprising (a) sieving a porous carrier to a particle size of at least 0.5 mm, and (b) combining the sieved porous carrier with a liquid phase change material.

2. The process of claim 1, wherein the carrier is one or more of an expanded perlite, high density polyethylene, styrene, butadiene, zeolite, diatomaceous earth, vermiculite, plaster or gypsum, concrete, expanded graphite, or clay mineral.

3. The process of claim 2, wherein the carrier is an expanded perlite.

4. The process of claim 2, wherein the carrier is a zeolite.

5. The process of claim 1, wherein the porous carrier has a density of less than 10 lb per cubic foot.

6. The process of claim 1, wherein the particle size is approximately 0.5 mm-10.0 mm.

7. The process of claim 1, wherein the particle size is approximately 0.5 mm-4.0 mm.

8. The process of claim 1, wherein the particle size is greater than approximately 10.0 mm.

9. The process of claim 1, wherein the phase change material is an alkane.

10. The process of claim 9, wherein the alkane is one or more of tetradecane, hexadecane, and oxadecane.

11. The process of claim 1, wherein the process further comprises (d) performing a vacuum step.

12. The process of claim 1, further comprising (e) adding particles of one or more dry materials.

13. The process of claim 12, wherein the fine particles are dry expanded perlite particles.

14. The process of claim 13, wherein the dry particle size is from approximately 0.2 mm to 1.0 mm.

15. The process of claim 1, wherein the phase change material is 40% or more of the final composition by volume.

16. The process of claim 1, wherein the phase change material has a melt point between −30° C. and 100° C.

17. A process of manufacturing a form stabilized phase change material, comprising: (a) sieving a porous perlite having a density of less than 10 lb per cubic foot to a particle size of approximately 0.5 mm-10.0 mm; (b) combining the sieved porous perlite with a liquid phase change material; (c) performing a vacuum step; (d) draining excess phase change material; and (e) adding perlite particles having a particle size of approximately 0.2 mm-1.0 mm; wherein the phase change material is 40% or more of the final composition by volume.

18. A form stabilized phase change composition comprising (a) a porous perlite carrier having a density of less than 101b per cubic food and with a particle of approximately 0.5-10.0 mm size; and (b) a phase change material comprising at least one alkane; wherein the perlite carrier is impregnated with the at least one alkane.

19. The composition of claim 18, wherein the further comprising at least one building material.

20. The composition of claim 18, wherein the composition comprises a packing or shipping container.
